(19) United States
(12) Patent Application Publication
(10) Pub. No.: US 2009/0066336 A1
(43) Pub. Date: Mar. 12, 2009

(54) Apparatus and Method for Electrically Investigating a Borehole

(75) Inventor: Dominique Dion, Plaisir (FR)

Correspondence Address: SCHLUMBERGER OILFIELD SERVICES, 200 GILLINGHAM LANE, MD 200-9, SUGAR LAND, TX, 77478, US

(73) Assignee: Schlumberger Technology Corporation, Sugar Land, TX (US)

(21) Appl. No.: 12/046,537

(22) Filed: Mar. 12, 2008

(30) Foreign Application Priority Data
Mar. 13, 2007 (EP) 07290316.4

(51) Int. Cl. G01V 3/20; G01V 3/38

(52) U.S. Cl. 324/355; 702/7

(57) ABSTRACT

An apparatus used in electrical investigation of geological formations GF surrounding a borehole BH, comprises:
an electrically conductive body 102 movable through the borehole BH,
at least one first transmitter T1 for inducing a first current from a first transmitter position and traveling in a path that includes a first portion of the body and a selected zone SZ of the geological formations GF,
at least one second transmitter T2 for inducing a second current from a second position and traveling in a path that includes a second portion of the body and the selected zone SZ, the second transmitter T2 position being different from the first transmitter T1 position on the body,
at least a first M0, second M1 and third M2 axial current sensors for measuring a first, a second and a third axial current flowing along the body, respectively, the first, second and third axial current sensor position on the body being different from each other, and
at least one lateral current sensor R2 disposed on the body for measuring a first electrical signal resulting from the first current and a second electrical signal resulting from the second current.

The apparatus further comprises:
a virtual axial current sensor providing a virtual axial current measurement by interpolating or extrapolating two axial current measurements made at different positions which are not adjacent to the lateral current sensor, and
an electronic module 103 for deriving an indication of the resistivity or conductivity of the selected zone SZ based on the measured first electrical signal, second electrical signal, axial currents and the calculated virtual axial current.

### FIELD OF THE INVENTION

An aspect of the invention relates to an apparatus used for the electrical investigation of a borehole penetrating geological formations. The apparatus and method enables lateral measurement of the resistivity of the geological formations surrounding the borehole. Another aspect of the invention relates to a method used for the electrical investigation of a borehole penetrating geological formations. The invention finds a particular application in the oilfield industry.

### BACKGROUND OF THE INVENTION

FIG. 1A schematically shows a typical onshore hydrocarbon well location and surface equipments SE above hydrocarbon geological formations GF after drilling operations have been carried out. At this stage, i.e. before a casing string is run and before cementing operations are carried out, the wellbore is a borehole BH filled with a fluid mixture MD. The fluid mixture MD is typically a mixture of drilling fluid and drilling mud. In this example, the surface equipments SE comprise an oil rig and a surface unit SU for deploying a logging tool TL in the well-bore. The surface unit may be a vehicle coupled to the logging tool by a line LN. Further, the surface unit comprises an appropriate device DD for determining the depth position of the logging tool relatively to the surface level. The logging tool TL comprises an electrical logging apparatus that performs electrical investigation of the geological formation GF in order to determine the electric properties, e.g. the resistivity of the geological formation GF surrounding the borehole BH. The logging tool may comprise various other sensors and may provide various measurement data related to the hydrocarbon geological formation GF and/or the fluid mixture DM. These measurement data are collected by the logging tool TL and transmitted to the surface unit SU. The surface unit SU comprises appropriate electronic and software arrangements PA for processing, analyzing and storing the measurement data provided by the logging tool TL. Once the logging tool TL is positioned at a desired depth, a plurality of backup springs BS can be deployed from one side of the tool TL in order to apply the other side of the tool TL against the borehole wall BW. Those versed in the art will recognize that any other appropriate deploying arrangement that is well known in the art can also be used. The resistivity or conductivity of a selected zone SZ can be measured by the electrical logging apparatus. Such a measurement can be repeated for other azimuth and other depth so as to obtain electric images of the borehole wall and a resistivity log of the geological formations.

FIG. 1B schematically shows a typical onshore hydrocarbon well location and surface equipments SE above hydrocarbon geological formations GF during drilling operations. Those versed in the art know that the electrical logging apparatus of FIG. 1A can also be adapted into a logging-while-drilling tool by mounting the logging tool TL on a drill collar. More precisely, a typical logging-while-drilling tool is incorporated into a bottom-hole assembly attached to the end of a drill string DS with a drill bit DB attached at the extreme end thereof. Measurements can be made either when the drill string is stationary or rotating. In the latter case an additional measurement is made to allow the measurements to be related to the rotational position of the drill string in the borehole. This is done by making simultaneous measurements of the direction of the earth's magnetic field with a compass, which can be related to a reference measurement made when the drill string is stationary. The measurement data that are collected by the logging tool TL may be transmitted by means of the known mud pulse technique to the surface unit SU coupled to a mud pulse receiver MP.

FIGS. 2 and 3 schematically illustrate an apparatus used in electrical investigation of geological formations surrounding a borehole as illustrated in EP 0 540 425 or U.S. Pat. No. 5,339,037.

FIG. 2 shows an electrical investigation apparatus 1 comprising a conductive body 2, two transmitters T1, T2, two axial current sensors M0, M2, one lateral current sensor R and an electronic module 3. The elongated conductive body 2 can be run into the borehole BH. Each transmitter T1, T2 is a toroidal antenna that can apply a potential difference between two conductive sections of the body, sending a current in a path that includes the body and the earth formation. The first transmitter T1 induces a first current. The second transmitter T2 induces a second current. Each axial current sensor M0, M2 is a toroidal antenna surrounding the body that can measure the axial current flowing along the body, or between two adjacent conductive sections of the body. The lateral current sensor R is an electrode that can measure the current either leaving or entering a section of the body's surface. The lateral current sensor R measures a first electrical signal resulting from the first current and a second electrical signal resulting from the second current.

The electronic module 3 or electronic and software arrangement PA of the surface unit SU may derive an indication of the conductivity of the geological formations as being proportional to:

(R1×M02+R2×M01)/M21,

where:

R1 designates the first electrical signal measured when the transmitter T1 is energized,

R2 designates the second electrical signal measured when the transmitter T2 is energized,

M02 designates the axial current measured by sensor M0 when transmitter T2 is energized,

M01 designates the axial current measured by sensor M0 when transmitter T1 is energized, and

M21 designates the axial current measured by sensor M2 when transmitter T1 is energized.

FIG. 3 shows an electrical investigation apparatus 11 having a structure configuration similar to the electrical investigation apparatus 1 of FIG. 2 with two additional lateral current sensors. More precisely, the electrical investigation apparatus 11 comprises the lateral current sensors R1, R2 and R3. Each lateral current sensor is positioned at a different distance from the first transmitter T1. The third lateral current sensor R3 is positioned closely to the axial current sensor M0. The first and second lateral current sensors R1 and R2 are positioned between the first transmitter T1 and the axial current sensor M0, but away from the axial current sensor M0. Each lateral current sensor enables deriving an indication of the resistivity of the geological formations at a different radial depth of investigation.

With the hereinbefore configurations, the hereinbefore formula gives accurate results with the lateral current sensor R or R3 positioned closely to the axial current sensor M0, but less accurate results with the lateral current sensor R1 or R2. Thus, it is necessary that each lateral current sensor is positioned closely to an axial current sensor when an apparatus is used to measure the geological formations at a different radial depth of investigation.

Thus, the prior art apparatus and method have difficulty in precisely focusing the survey current in a selected zone of the geological formations. The prior art apparatuses and methods are complex because each axial current sensor must be associated with a close lateral current sensor for measuring the resistivity at different radial depth of investigation with sufficient accuracy. Otherwise, the calculation of the resistivity results in a lack of accuracy. Further, it may not be mechanically or economically possible to position an axial current sensor closely to each lateral current sensor, particularly in configuration where there are various lateral sensors at different axial position.

### SUMMARY OF THE INVENTION

It is an object of the invention to propose an apparatus and a method that overcomes at least one of the drawbacks of the prior art apparatus and method.

According to a first aspect, the invention relates to an apparatus used in electrical investigation of geological formations surrounding a borehole, comprising:
an electrically conductive body movable through the borehole,
at least one first transmitter for inducing a first current from a first transmitter position and traveling in a path that includes a first portion of the body and a selected zone of the geological formations,
at least one second transmitter for inducing a second current from a second position and traveling in a path that includes a second portion of the body and the selected zone, the second transmitter position being different from the first transmitter position on the body,
at least a first, second and third axial current sensors for measuring a first, a second and a third axial current flowing along the body, respectively, the first, second and third axial current sensor position on the body being different from each other, and
at least one lateral current sensor disposed on the body and electrically isolated from the body for measuring a first electrical signal resulting from the first current and a second electrical signal resulting from the second current.

The apparatus further comprises:
a virtual axial current sensor providing a virtual axial current measurement by interpolating or extrapolating two axial current measurements made at different positions which are not adjacent to the lateral current sensor, and
an calculating module for deriving an indication of the resistivity or conductivity of the selected zone based on the measured first electrical signal, second electrical signal, axial currents and the calculated virtual axial current.

The at least one lateral current sensor may be formed by the first and second axial current sensors and may determine a lateral current based on a difference of the first axial current measured by the first axial current sensor and the second axial current measured by the second axial current sensor.

One of the axial current sensors may be positioned adjacent to the transmitter. A common antenna may selectively form an axial current sensor or a transmitter. At least one of the axial current sensors may be positioned adjacent to a lateral current sensor.

The transmitter may be a toroidal antenna or an electrode.

The axial current sensor may be a toroidal antenna.

The lateral current sensor may be a ring electrode or a button electrode.

According to a further aspect, the apparatus used in electrical investigation of geological formations surrounding a borehole may comprise:
an electrically conductive body movable through the borehole,
at least one first transmitter for inducing a first current from a first transmitter position and traveling in a path that includes a first portion of the body and a selected zone of the geological formations,
at least one second transmitter for inducing a second current from a second position and traveling in a path that includes a second portion of the body and the selected zone, the second transmitter position being different from the first transmitter position on the body,
at least a first and second axial current sensors for measuring a first and a second axial current flowing along the body, respectively, the first and second axial current sensor position on the body being different from each other, and
a virtual axial current sensor providing a virtual axial current measurement by interpolating or extrapolating the measured first and second axial current.

According to another aspect, the invention relates to a method of electrical investigation of geological formations surrounding a borehole, comprising the steps of:
positioning an electrically conductive body movable through the borehole in front of a selected zone of the geological formations,
inducing a first current from a first transmitter position that travels in a path that includes a first portion of the body and the selected zone, and a second current from a second transmitter position that travels in a path that includes a second portion of the body and the selected zone, the second transmitter position being different from the first transmitter position on the body,
measuring a first, a second and a third axial current flowing along the body, respectively, at a first, second and third axial current sensor position on the body that are different from each other,
measuring a first electrical signal resulting from the first current and a second electrical signal resulting from the second current by means of at least one lateral current sensor disposed on the body.

The method further comprises the steps of:
calculating a virtual axial current measurement by interpolating or extrapolating two axial current measurements made at different positions which are not adjacent to the lateral current sensor position, and
deriving an indication of the resistivity or conductivity of the selected zone based on the measured first electrical signal, second electrical signal, axial currents and the calculated virtual axial current.

The step of calculating a lateral current may be based on a difference of the first axial current measured by the first axial current sensor and the second axial current measured by the second axial current sensor.

According to still a further aspect, the invention relates to a method of electrical investigation of geological formations surrounding a borehole, comprising the steps of:
positioning an electrically conductive body movable through the borehole in front of a selected zone of the geological formations,
inducing a first current from a first transmitter position that travels in a path that includes a first portion of the body and the selected zone, and a second current from a second transmitter position that travels in a path that includes a second portion of the body and the selected zone, the second transmitter position being different from the first transmitter position on the body,
measuring a first and a second axial current flowing along the body, respectively, at a first and second axial current sensor position on the body that are different from each other, and
calculating a virtual axial current measurement by interpolating or extrapolating the measured first and second axial current.

The virtual axial current sensor of the invention provides improved focusing for the lateral current sensor. Thus, the invention enables focusing the resistivity measurements to a well defined selected zone of the geological formation than prior art apparatus and method. Consequently, with the invention, the vertical resolution is improved and the shoulder bed effect is reduced while a satisfactory radial depth of investigation is maintained. The corresponding resistivity can be calculated with a greater accuracy than prior art apparatus and method.

These and other aspects of the invention will be apparent from and elucidated with reference to the embodiments described hereinafter.

### BRIEF DESCRIPTION OF THE DRAWINGS

The present invention is illustrated by way of example and not limited to the accompanying figures, in which like references indicate similar elements:

FIGS. 1A and 1B schematically illustrate typical onshore hydrocarbon well locations;

FIGS. 2 and 3 schematically illustrate an apparatus used in electrical investigation of geological formations surrounding a borehole according to the prior art;

FIGS. 4, 5, 6 and 7 schematically illustrate an apparatus used in electrical investigation of geological formations surrounding a borehole according to a first, second, third and fourth embodiment of the invention, respectively;

FIGS. 8 and 10 are graphics showing conductance as a function of depth with the apparatus according to the fourth embodiment of the invention, the conductance being measured without focusing;

FIG. 9 is a graphic showing conductance as a function of depth with the apparatus according to the fourth embodiment of the invention and focused measurement; and

FIG. 11 is a graphic showing conductance as a function of depth with the apparatus according to the fourth embodiment of the invention and focused differential measurement.

### DETAILED DESCRIPTION OF THE INVENTION

In the following description, the terminology “radial depth of investigation” defines a dimension around the borehole along the circumference whatever the orientation of the borehole, namely horizontal, vertical or inclined.

Further, the terminology “electronic module” defines an entity made of electronic circuit, software or a combination of both that can performed a plurality of functions that is known by those versed in the art. For example, the electronic module may comprise a processing module for calculation purpose, a power amplifier module for energizing the transmitters, a control module for switching the function of the antenna from transmitter to sensor and vice-versa, a filtering module, a AND and D/A module, a memory for storing untreated measurements or calculation results, etc. . . .

Furthermore, in the following the indication of the conductivity is indicated as being equivalent to the inversed resistivity and proportional to the current. However, the skilled person knows that this is correct in the direct current case, while this is an approximation in the alternative current case because of the existence of a skin effect correction in particular in the high conductivity range. The skin effect correction is neglected in the following description.

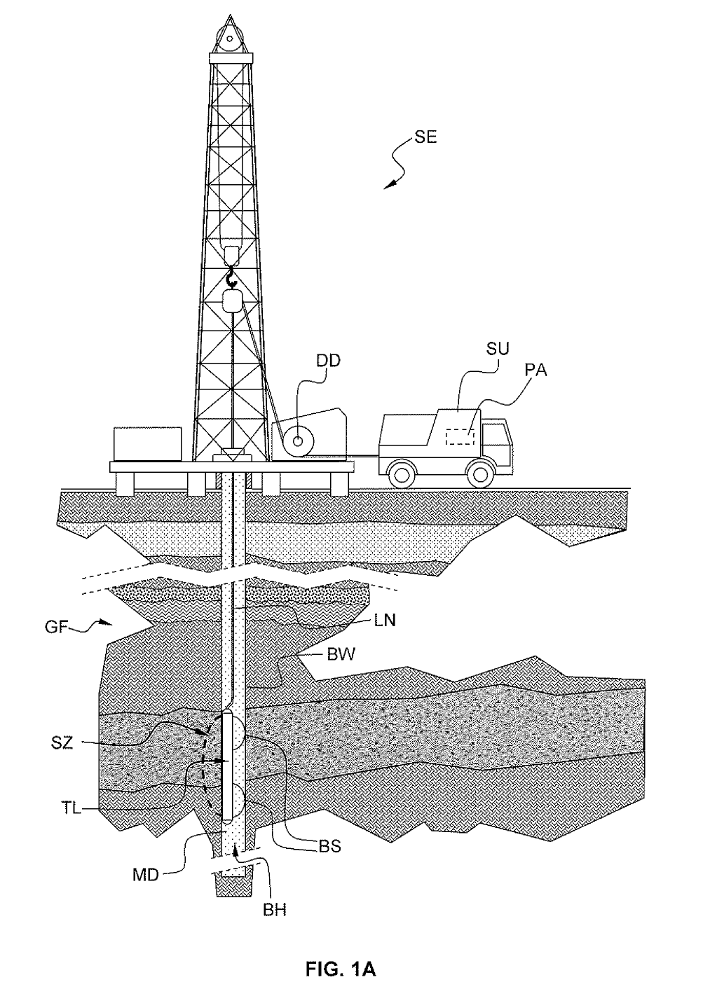

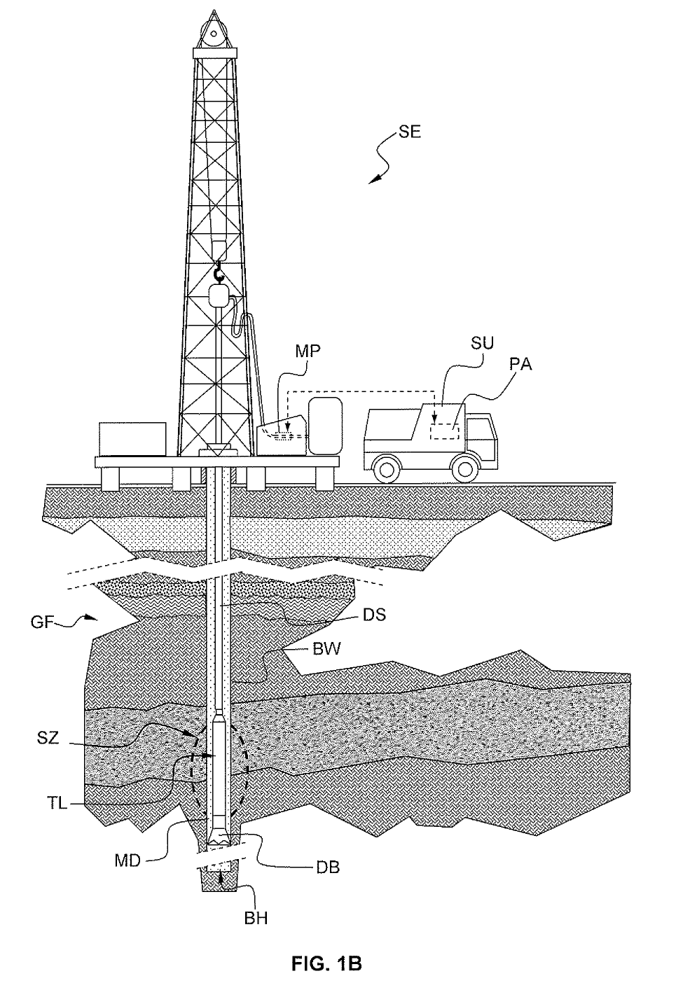

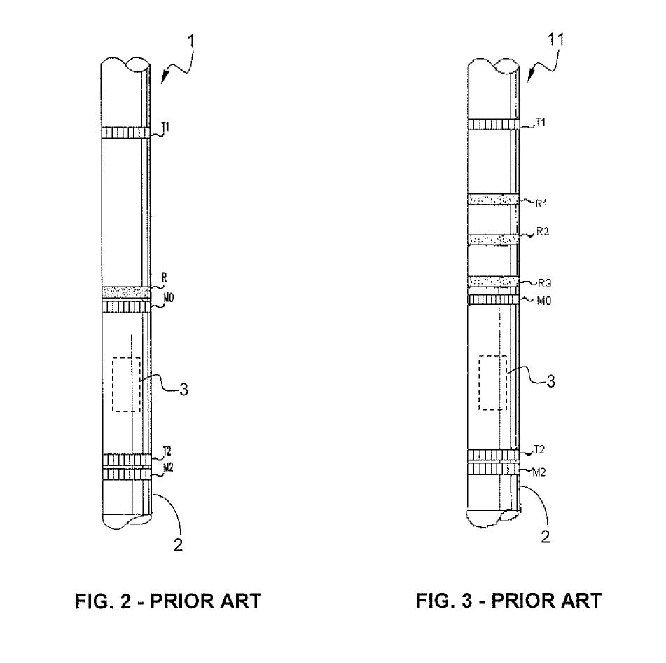

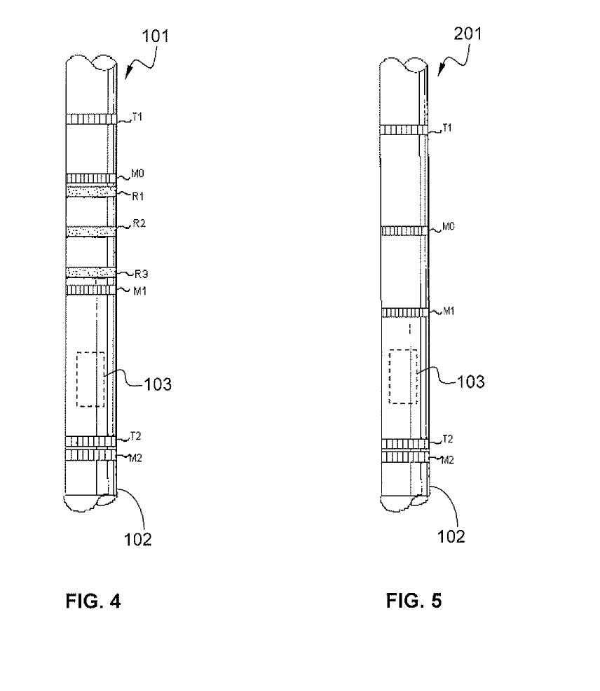

FIG. 4 schematically illustrates an electrical investigation apparatus 101 used in electrical investigation of geological formations surrounding a borehole according to a first embodiment of the invention. The apparatus 101 comprises a conductive body 102, two transmitters T1, T2, three axial current sensors M0, M1, M2, three lateral current sensors R1, R2, R3 and an electronic module 103. The conductive body 102 is movable through the borehole BH (cf. FIG. 1). Once the apparatus is positioned at a desired depth in the borehole, the electrical properties (i.e. resistivity and/or conductivity) of a selected zone of the geological formations in front of the apparatus can be measured.

The first transmitter T1 can induce a first current that travels from the first transmitter position in a path that includes a first portion of the body and the selected zone of the geological formations. The second transmitter T2 can induce a second current that travels from the second transmitter position in a path that includes a second portion of the body and the selected zone of the geological formations.

The first M0, second M1 and third M2 axial current sensor measures the axial current flowing along the body at the first, second and third axial current sensor position, respectively.

Each of the first R1, second R2 and third R3 lateral current sensor measures a first electrical signal resulting from the first current and a second electrical signal resulting from the second current induced by the transmitter. Each lateral current sensor being positioned at a different distance from the transmitter, it measures the electrical properties of the selected zone at a different radial depth relatively to the borehole axis.

The electronic module 103 derives an indication of the resistivity and/or conductivity of the formations based on said measured electrical signals and currents.

According to the invention, a virtual axial current sensor is provided. The virtual axial current sensor provides a virtual axial current measurement by interpolating or extrapolating two axial current measurements made at different locations which are not adjacent to the lateral current sensor. More precisely, the lateral current sensor R2 is focused with a virtual axial current sensor derived by interpolating the axial current measured by the first M0 and second M1 axial current sensor.

In the example of FIG. 4, the lateral current sensor R2 is located half way between the first M0 and second M1 axial current sensor, resulting in that the virtual axial current sensor measures a first virtual current VC1 proportional to (M01+M11)/2 when the first transmitter T1 is energized and a second virtual current VC2 proportional to (M02+M12)/2 when the second transmitter T2 is energized. In this example, the electronic module 103 derives an indication of the conductivity (or inversed resistivity) of the geological formations as being approximately proportional to:

(R21×VC2+R22×VC1)/M21,
which is equal to:

$$( R 21 \times ( \frac{M 02 + M 12}{2} ) + R 22 \times ( \frac{M 01 + M 11}{2} ) ) / M 21 ,$$

where:

R21 designates the first electrical signal (current measured by lateral current sensor R2 when the first transmitter T1 is energized),

R22 designates the second electrical signal (current measured by lateral current sensor R2 when the second transmitter T2 is energized),

VC1 and VC2 designates the first and second virtual current, respectively,

M02 designates the axial current measured by axial current sensor M0 when transmitter T2 is energized,

M12 designates the axial current measured by axial current sensor M1 when transmitter T2 is energized,

M01 designates the axial current measured by axial current sensor M0 when transmitter T1 is energized,

M11 designates the axial current measured by axial current sensor M1 when transmitter T1 is energized, and

M21 designates the axial current measured by axial current sensor M2 when transmitter T1 is energized.

The above formula can be generalized such that an indication of the conductivity (or inversed resistivity) of the geological formations is approximately proportional to:

$$[ \frac{R 21 \times ( a \times M 02 + b \times M 12 )}{a + b} + \frac{R 22 \times ( a \times M 01 + b \times M 11 )}{a + b} ] / M 21 ,$$

where:

a designates the distance between the lateral current sensor R2 and the axial current sensor M1, and

b designates the distance between the lateral current sensor R2 and the first axial current sensor M0.

In the particular example of FIG. 4, the distance from the lateral current sensor R1 to the axial current sensor M1 is nine times the distance from the lateral current sensor R1 to the axial current sensor M0. The measurement of the lateral current sensor R1 can be focused by a virtual axial current sensor at the location of R1. The virtual axial current sensor measures a first virtual current VC1′ proportional to 0.9×M01+0.1×M11 when the first transmitter T1 is energized and a second virtual current VC2′ proportional to 0.9×M02+0.1×M12 when the second transmitter T2 is energized. In this example, the electronic module 103 derives an indication of the conductivity (or inversed resistivity) of the geological formations in front of the lateral current sensor R1 as being approximately proportional to:

(R11×VC2′+R12×VC1′)/M21,

which is equal to:

[R11×(0.9×M02+0.1×M12)+R12×(0.9×M01+0.1×M11)]/M21

where:

R11 designates the first electrical signal (current measured by lateral current sensor R1 when the first transmitter T1 is energized), and

R12 designates the first electrical signal (current measured by lateral current sensor R1 when the first transmitter T1 is energized).

FIG. 5 schematically illustrates an electrical investigation apparatus 201 used in electrical investigation of geological formations surrounding a borehole according to a second embodiment of the invention. The apparatus 201 comprises a conductive body 102, two transmitters T1, T2, three axial current sensors M0, M1, M2 and an electronic module 103. The second embodiment mainly differs from the first one in that the second embodiment does not comprise the three lateral current sensors R1, R2, R3.

Similarly to the first embodiment, the first T1 and second T2 transmitter can induce a first and a second current, respectively, that travels from the first and second transmitter position, respectively, in a path that includes a first and second portion of the body and the selected zone of the geological formations, respectively.

The first M0, second M1 and third M2 axial current sensor measures the axial current flowing along the body at the first, second and third axial current sensor position, respectively. The first M0 and second M1 axial current sensors are positioned between the first T1 and second T2 transmitters. The third axial current sensor M2 is positioned dosed to the second transmitter T2.

The electronic module 103 derives an indication of the resistivity and/or conductivity of the formations based on said measured electrical signals and currents.

In the example of FIG. 5 and according to the invention, a virtual axial current sensor and a lateral current sensor are provided. The virtual axial current sensor provides a virtual axial current measurement by interpolating or extrapolating two axial current measured by the first M0 and second M1 axial current sensor at their respective position. The lateral current sensor, formed by the combination of the first M0 and second M1 axial current sensor, determines a lateral current based on the difference of axial current measured by the first axial current sensor M0 and second axial current sensor M1. Alternatively, the lateral current sensor can be formed by the two toroidal transformers M0 and M1 mounted in series-opposition as described in U.S. Pat. No. 3,305,771. The lateral current sensor covers the entire selected zone between the locations of the first M0 and second M1 axial current sensor. The virtual axial current sensor is located half way between the first M0 and second M1 axial current sensors. In this example, the electronic module 103 derives an indication of the conductivity (or inversed resistivity) of the geological formations as being approximately proportional to:

$$( ( M 01 - M 11 ) \times ( \frac{M 02 + M 12}{2} ) + ( M 12 - M 02 ) \times ( \frac{M 01 + M 11}{2} ) ) / M 21 ,$$

which is equal to:

(M12×M01−M02×M11)/M21.

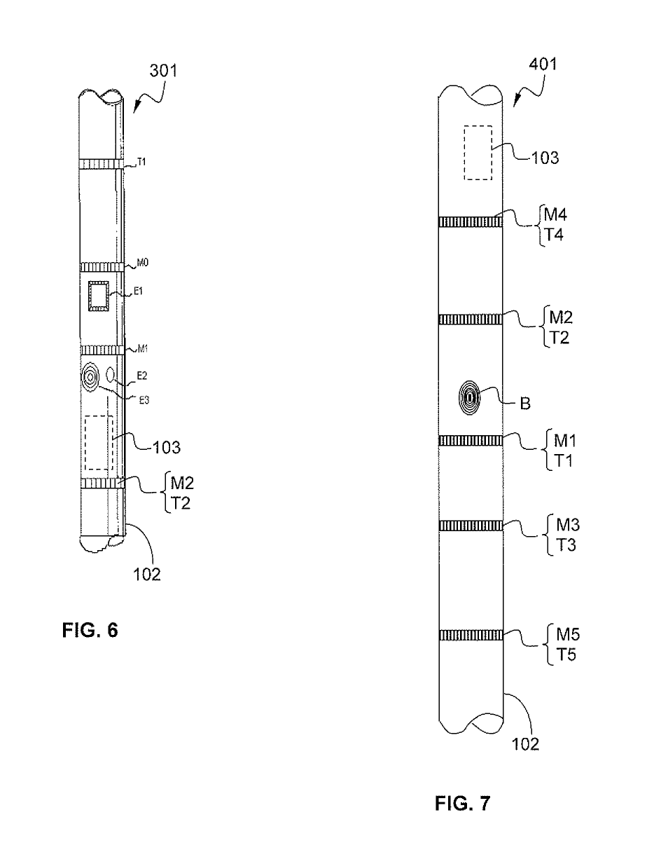

FIG. 6 schematically illustrates an electrical investigation apparatus 301 used in electrical investigation of geological formations surrounding a borehole according to a third embodiment of the invention. The apparatus 301 comprises a conductive body 102, a first transmitter T1, two axial current sensors M0 and M1, a common antenna used either as a second transmitter T2 or a third axial current sensor M2, three lateral current sensors with azimuthal sensitivity E1, E2, E3, and an electronic module 103. An additional lateral current sensor, formed by the combination of the first M0 and second M1 axial current sensor, is also provided by computing the difference between axial currents measured by the axial current sensors M0 and M1, or by connecting two toroidal transformers in series-opposition as described in U.S. Pat. No. 3,305,771. The lateral current sensor covers the entire selected zone between the locations of the axial current sensors M0 and M1. The third embodiment mainly differs from the second one in that it comprises, in addition to the lateral sensor formed by the axial current sensor M0 and M1, three lateral current sensors with azimuthal sensitivity E1, E2, E3, and a common antenna used either as transmitter T2 or as axial current sensor M2.

Similarly to the first embodiment, the first transmitter T1 and the common antenna used either as transmitter T2 can induce a first and a second current, respectively, that travels from the first and second transmitter position, respectively, in a path that includes a first and second portion of the body and the selected zone of the geological formations, respectively.

The first M0 and second M1 axial current sensors and the common antenna used as a third axial current sensor M2 measures the axial current flowing along the body at the first, second and third axial current sensor position, respectively. The first M0 and second M1 axial current sensors are positioned between the first T1 and second T2 transmitters. The position of the third axial current sensor M2 is identical to the position of the second transmitter T2.

In this embodiment, the same toroidal antenna is alternatively a transmitter T2 and an axial current sensor M2 when the first transmitter T1 is energized. For example, the antenna is automatically switched from one function to the other by a control and switch circuit (not shown) of the electronic module 103.

The electronic module 103 derives an indication of the resistivity and/or conductivity of the formations based on said measured electrical signals and currents.

In the example of FIG. 6 and according to the invention, a virtual axial current sensor is provided. The virtual axial current sensors provide virtual axial current measurements by interpolating or extrapolating two axial currents measured by the first M0 and second M1 axial current sensor at their respective position. The lateral current determined by the difference between the axial current measurements at sensors M0 and M1, or by connecting the first M0 and second M1 axial current sensor in series-opposition, can be focused with the virtual axial current sensor derived from interpolating the measurements of the first M0 and second M1 axial current sensors.

The lateral current sensor E1 is a current transformer recessed in the body 102. The lateral current sensor E2 is an electrode insulated from the body 102. The lateral current sensor E3 is a button electrode, i.e an array of current measuring electrodes and voltage sensing electrodes (such a button electrode is described in details in U.S. Pat. No. 6,373,254). Advantageously, all these lateral current sensors have an azimuthal sensitivity.

The lateral current measurements made by the lateral current sensor E1 can be focused with the virtual axial current sensor derived from interpolating the measurements of the first M0 and second M1 axial current sensors.

The lateral current measurement made by the lateral current sensor E2 or E3 can be focused with the virtual axial current sensor derived from extrapolating the measurements of the first M0 and second M1 axial current sensors.

The electronic module 103 derives an indication of the conductivity (or inversed resistivity) of the geological formations in a way similar to the one described in relation with FIG. 4.

FIG. 7 schematically illustrates an electrical investigation apparatus 401 used in electrical investigation of geological formations surrounding a borehole according to a fourth embodiment of the invention. It is to be emphasized that in the fourth embodiment, the number of transmitter and axial current sensor is only an example, those skilled in the art may easily adapt the invention to less or more transmitter and axial current sensor. The apparatus 401 comprises a conductive body 102, a first common antenna used either as a first transmitter T1 or a first axial current sensor M1, a second common antenna used either as a second transmitter T2 or a second axial current sensor M2, a third common antenna used either as a third transmitter T3 or a third axial current sensor M3, a fourth common antenna used either as a fourth transmitter T4 or a fourth axial current sensor M4, a fifth common antenna used either as a fifth transmitter T5 or a fifth axial current sensor M5, a lateral current sensor B, and an electronic module 103.

In this embodiment all the common antennas can be used alternatively as a transmitter and as an axial current sensor. Each common antenna when acting as a transmitter T1, T2, T3, T4, T5 can induce a current that travels from the transmitter position in a path that includes a portion of the body and the selected zone of the geological formations. The common antennas are toroidal antenna.

Each common antenna when acting as an axial current sensor M1, M2, M3, M4, M5 measures the axial current flowing along the body at the axial current sensor position. As an example, the common antenna may be positioned all along the body 102 with each common antenna at an equal distance from a directly adjacent common antenna. As an example, the lateral current sensor B may be positioned between the first common antenna T1, M1 and the second common antenna T2, M2. The lateral current sensor B may be a button electrode which is described in details in U.S. Pat. No. 6,373,254.

The five common antennas which are alternatively used as transmitter and as axial current sensor enables obtaining focused measurements at four different radial depths of investigation from the single lateral current sensor B. More precisely, in turn, each common antenna is used as a transmitter, while the four other common antennas can be used as axial current sensors. Alternatively, time multiplexing and/or frequency multiplexing on subsets of the five common antennas can be implemented.

The automatic switching of the common antenna from one function to the other, or the time multiplexing and/or frequency multiplexing may be implemented by a control and switch module (not shown) of the electronic module 103. Such an electronic module is known in the art and will not be further described.

The lateral current measurements made by the lateral current sensor B can be focused with a virtual axial current sensor. The virtual axial current sensor is derived from interpolating the measurements of two common antennas, both antennas being operated as axial current sensors.

With the fourth embodiment of FIG. 7, at least two focused conductivities with various radial depth of investigation can be determined.

With increasing radial depth of investigation, a first focused conductivity measurement CB3 or CM3 can be determined by energizing the third T3 and fourth T4 transmitters, and a second focused conductivity measurement CB4 or CM4 can be determined by energizing the fourth T4 and fifth T5 transmitters.

As an example related to the second measurement CB4 or CM4, the electronic module 103 derives an indication of the conductivity (or inversed resistivity) of the geological formations as being approximately proportional to:

$$CB 4 = ( B 4 \times ( \frac{a \times M 15 + b \times M 25}{a + b} ) + B 5 \times ( \frac{a \times M 14 + b \times M 24}{a + b} ) ) / M 54$$

or with the lateral current sensor comprising the space between the axial current sensors M1 and M2:

CM4=(M24×M15−M14×M25)/M54

where:

B4 designates the current measured by lateral current sensor B when the fourth transmitter T4 is energized,

B5 designates the current measured by lateral current sensor B when the fifth transmitter T5 is energized,

b designates the distance between the lateral current sensor B and the first common antenna T1, M1,

a designates the distance between the lateral current sensor B and the second common antenna T2, M2,

M15 designates the axial current measured by axial current sensor M1 when transmitter T5 is energized,

M25 designates the axial current measured by axial current sensor M2 when transmitter T5 is energized,

M14 designates the axial current measured by axial current sensor M1 when transmitter T4 is energized,

M24 designates the axial current measured by axial current sensor M2 when transmitter T4 is energized, and

M54 designates the axial current measured by axial current sensor M5 when transmitter T4 is energized.

Similar formulae can be determined for the third measurements CB3 or CM3.

In the general case using as transmitters the antenna Ti (i>2) and the common antenna Tj, Mj (j>i), the electronic module 103 derives an indication of the conductivity (or inversed resistivity) of the geological formations as being approximately proportional to:

$$CBi = ( Bi \times ( \frac{a \times M 1 j + b \times M 2 j}{a + b} ) + Bj \times ( \frac{a \times M 1 i + b \times M 2 i}{a + b} ) ) / Mji$$

or with the lateral current sensor comprising the space between the axial current sensors M1 and M2:

CMi=|M2i×M1j−M1i×M2|/Mji

where:

Bi designates the current measured by lateral current sensor B when the transmitter Ti is energized,

Bj designates the current measured by lateral current sensor B when the transmitter Tj is energized,

b designates the distance between the lateral current sensor B and the first common antenna T1, M1,

a designates the distance between the lateral current sensor B and the second common antenna T2, M2,

M1j designates the axial current measured by axial current sensor M1 when transmitter Tj is energized,

M2j designates the axial current measured by axial current sensor M2 when transmitter Tj is energized,

M1i designates the axial current measured by axial current sensor M1 when transmitter T1 is energized,

M2i designates the axial current measured by axial current sensor M2 when transmitter T1 is energized, and

Mji designates the axial current measured by axial current sensor Mj when transmitter T1 is energized.

In the fourth embodiment, at least four antennas may be required, namely one transmitting antenna Ti, two receiving antennas M1, M2, and at least one common antenna Tj, Mj. Advantageously, the antennas Ti, M1 and M2 may also be common antenna in order to enable others measurements at a different radial depth of investigation.

In the above general case presented hereinbefore, it will be apparent to those versed in the art that, by reciprocity, the transmitters and current sensors can be inverted without departing from the scope of the present invention. In particular, a reciprocal sensor arrangement can be designed by replacing the antennas Ti, M1, M2 and (Tj, Mj) by the antennas Mi, T1, T2, and (Mj, Tj), respectively. In this case, T1, T2, Tj are transmitters, and M1 and M2 are axial current sensors.

The above formula becomes:

CMi=|Mi2×Mj1−Mi1×Mj2|/Mij

where:

Mi2 designates the axial current measured by axial current sensor Mi when transmitter T2 is energized,

Mj2 designates the axial current measured by axial current sensor Mj when transmitter T2 is energized,

Mi1 designates the axial current measured by axial current sensor Mi when transmitter T1 is energized,

Mj1 designates the axial current measured by axial current sensor Mj when transmitter T1 is energized, and

Mij designates the axial current measured by axial current sensor Mi when transmitter Tj is energized. Thus, the invention is an improvement over the prior art because in the prior art, the difference of two large numbers (M2i−M1i) is considered. The difference of two large numbers is subject to a large error if either one of the two current sensors has an incorrect gain or scale factor. In contradistinction, with the invention, if one of the sensors has an incorrect gain or scale factor, the same error in percentage is made on both terms of the subtraction. As a consequence, the relative error on the focused measurement is not amplified.

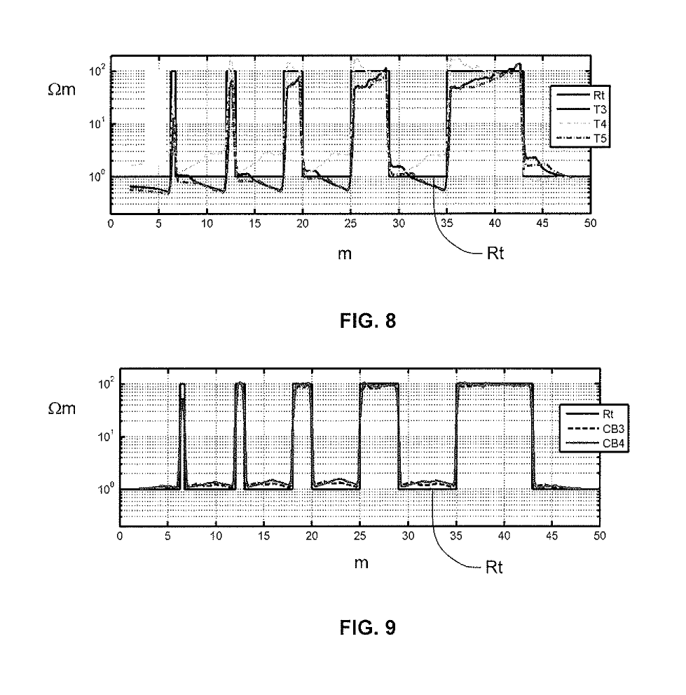

FIG. 8 is a graphic showing conductivity as a function of depth with the apparatus according to the fourth embodiment of the invention, the conductivity being measured without focusing. The log has been performed by simulating a portion of geological formation comprising beds of alternating resistivity 1 Ωm and 100 Ωm and of varying thickness (illustrated by the plain curve referenced Rt). The unfocused measurements are the measurements of the lateral current sensor B with either the third T3, or the fourth T4 or the fifth T5 transmitter being energized. It is to be noted that the measurements resolution and accuracy of the conductivity (inverse of the resistivity) are poor.

FIGS. 9 and 11 highlight the improvement obtained with the focusing method of the invention. It also demonstrates that, with the apparatus and method of the invention, it is not necessary to closely associate an axial current sensor with a lateral current sensor for measuring the resistivity at different radial depth of investigation.

FIG. 9 is a graphic showing resistivity as a function of depth with the apparatus according to the fourth embodiment of the invention. More precisely, FIG. 9 shows the resistivity log resulting from the third CB3 and fourth CB4 focused conductivity measurements. The log has been performed in the same portion of geological formation as FIG. 8 that comprises beds of alternating resistivity 1 Ωm and 100 Ωm and of varying thickness (illustrated by the plain curve referenced Rt). It is to be noted that the measurements resolution and accuracy of the resistivities are excellent.

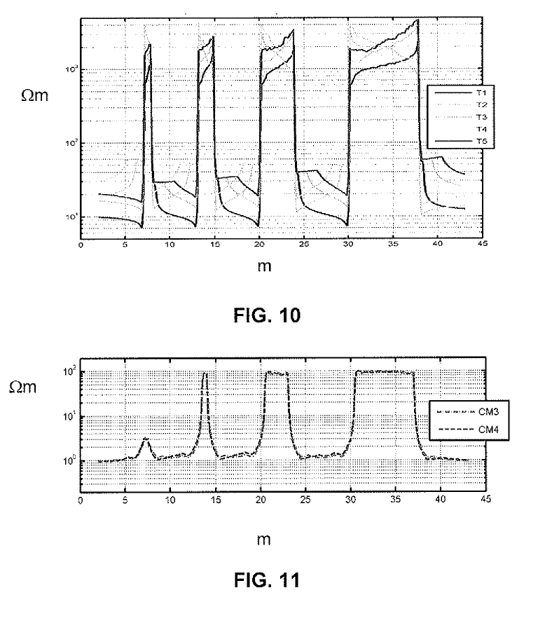

FIG. 10 illustrates unfocused measurements of the lateral current sensor B with either the first T1, or the second T2, or the third T3, or the fourth T4, or the fifth T5 transmitter being energized. It is to be noted that the measurements resolution and accuracy of the conductivity (inverse of the resistivity) are poor.

FIG. 11 is a graphic showing resistivity as a function of depth with the apparatus according to the fourth embodiment of the invention and focused differential measurement. More precisely, FIG. 11 shows the log resulting from the third CM3 and fourth CM4 focused differential measurements. The log has been simulated in a portion of geological formation as illustrated in FIG. 10 that comprises beds of alternating resistivity 1 Ωm and 100 Ωm and of varying thickness. It is to be noted that the measurements resolution is degraded compared to the focused conductivity measurements because the lateral current sensor is much larger. However, the measurements are very accurate in thick beds.

Final Remarks

It will be apparent for a person skilled in the art that the invention is applicable to onshore and offshore hydrocarbon well locations.

Further, those skilled in the art understand that the invention is not limited to vertical borehole as depicted in the drawings: the invention is also applicable to inclined borehole or horizontal borehole.

Furthermore, it will also be apparent to those skilled in the art that the calculation of the conductivity or resistivity according to the invention can be performed elsewhere than in an electronics module within the instrument; for example, the calculation can be performed at the surface.

Finally, it is also apparent for a person skilled in the art that application of the invention is not limited to the oilfield industry as the invention can also be applied in others types of geological surveys.

The drawings and their description hereinbefore illustrate rather than limit the invention.

Any reference sign in a claim should not be construed as limiting the claim. The word “comprising” does not exclude the presence of other elements than those listed in a claim. The word “a” or “an” preceding an element does not exclude the presence of a plurality of such element.

1. An apparatus for determining a property of a formation surrounding a borehole, the apparatus comprising:
an electrically conductive body (102) capable of being movably located in a borehole;
a plurality of transmitters (T1, T2) located at different positions on the body, each capable of inducing a current having a path that includes at least a portion of the body (102) and the formation;
a plurality of receivers (M0, M1) located at different positions on the body, each capable of measuring an axial current flowing along the body at the different positions; and
a processing module 103 for determining a virtual axial current at a position on the body that is used for determining the property of the formation, wherein the virtual axial current at said position is determined based on the measured axial currents from the plurality of receivers.

2. The apparatus of claim 1, wherein the processing module is capable of determining the virtual axial current at said position by interpolating the axial current measurements of the receivers.

3. The apparatus of claim 1, wherein the processing module is capable of determining the virtual axial current at the position by extrapolating the axial current measurements of the receivers.

4. The apparatus of claim 1, further comprising determining a lateral current at a position on the body that flows from said position on the body into the formation.

5. The apparatus of claim 4, wherein the lateral current is determined based on a difference in axial currents measured by at least two different receivers.

6. The apparatus of claim 4, wherein a lateral current sensor is arranged to determine the lateral current at said position.

7. The apparatus of claim 6, wherein the position of the lateral current sensor on the body is different to any of the positions of the plurality of receivers.

8. The apparatus of claim 4, wherein the processing module is capable of determining the formation property based on the virtual axial current and the lateral current.

9. The apparatus of claim 1, wherein the property of the formation to be determined is at least one of a resistivity and a conductivity.

10. The apparatus of claim 1, wherein at least one of the receivers (M2) is at a position adjacent to at least one of the transmitter positions (T2). (3)

11. The apparatus of claim 1, wherein a common antenna (M1/T1, M2/T2, M3/T3, M4/T4, M5/T5) selectively forms at least one of a receiver and a transmitter. (4)

12. The apparatus according to claim 6, wherein at least one of the receivers is positioned adjacent to the lateral current sensor (B). (5)

13. The apparatus according to claim 1, wherein
the plurality of transmitters having at least one first transmitter (T1) for inducing a first current from a first transmitter position and traveling in a path that includes a first portion of the body and a selected zone (SZ) of the geological formations (GF), and at least one second transmitter (T2) for inducing a second current from a second position and traveling in a path that includes a second portion of the body and the selected zone (SZ), the second transmitter (T2) position being different from the first transmitter (T1) position on the body;
the plurality of receivers having at least a first (M0), second (M1) and third (M2) axial current sensors for measuring a first, a second and a third axial current flowing along the body, respectively, the first, second and third axial current sensor position on the body being different from each other;
at least one lateral current sensor (R2, M0/M1, E1, E2, E3, B) disposed on the body for measuring a first electrical signal resulting from the first current and a second electrical signal resulting from the second current; and
the processing device (103) acts as a virtual axial current sensor providing a virtual axial current measurement by interpolating or extrapolating two axial current measurements made at different positions which are not adjacent to the lateral current sensor; and the processing device (103, PA) for deriving an indication of the resistivity or conductivity of the selected zone (SZ) based on the measured first electrical signal, second electrical signal, axial currents and the calculated virtual axial current.

14. The apparatus according to claim 13, wherein the first electrical signal is the current measured by the lateral current sensor (R2) when the first transmitter (T1) is energized and is designated R21, the second electrical signal is the current measured by the lateral current sensor (R2) when the second transmitter (T2) is energized and is designated R22, the axial current measured by the first axial current sensor (M0) when the second transmitter (T2) is energized is designated M02, the axial current measured by the second axial current sensor (M1) when the second transmitter (T2) is energized is designated M12, the axial current measured by the axial current sensor (M0) when the first transmitter (T1) is energized is designated M01, the axial current measured by the second axial current sensor (M1) when the first transmitter (T1) is energized is designated M11, the axial current measured by the third axial current sensor (M2) when the first transmitter (T1) is energized is designated M21, the lateral current sensor (R2) being positioned between the first (M0) and the second (M1) axial current sensor, the distance between the lateral current sensor R and the axial current sensor M0 is designated b, the distance between the lateral current sensor R and the axial current sensor M1 is designated a, and
wherein the calculating module (103, PA) derives the indication of the resistivity of the formation as being approximately inversely proportional to, or the indication of the conductivity of the formations as being approximately proportional to:
$$[ \frac{R 21 \times ( a \times M 02 + b \times M 12 )}{a + b} + \frac{R 22 \times ( a \times M 01 + b \times M 11 )}{a + b} ] / M 21.$$

15. The apparatus according to claim 13, wherein the first axial current measured by the first axial current sensor (M0) when the first transmitter (T1) is energized is designated M01, the second axial current measured by the second axial current sensor (M1) when the second transmitter (T2) is energized is designated M12, the third axial current measured by the first axial current sensor (M0) when the second transmitter (T2) is energized is designated M02, the fourth axial current measured by the second axial current sensor (M1) when the first transmitter (T1) is energized is designated M11, and
wherein the electronic module (103) derives the indication of the inverse of resistivity or conductivity of the formations as being approximately proportional to:
(M12×M01−M02×M11)/M21.

16. The apparatus according to claim 13, wherein the apparatus comprises:
at least four common antennas at different position along the body (102) used either as a transmitter (Ti, Tj) or as an axial current sensor (M1, M2, Mj), each common antenna being used as a transmitter while the other common antennas being used as axial current sensors, in turn, each transmitter inducing a current from a transmitter position and traveling in a path that includes a portion of the body and a selected zone (SZ) of the geological formations (GF);
at least one lateral current sensor (B) disposed on the body for measuring a first current designated Bi when the transmitter T1 is energized and a second current designated Bj when the transmitter Tj is energized;
the distance between the lateral current sensor (B) and the first common antennas (T1, M1) is designated b, the distance between the lateral current sensor (B) and the common antennas (T2, M2) is designated a;
wherein the axial current measured by axial current sensor M1 when transmitter Tj is energized is designated M1j, the axial current measured by axial current sensor M2 when transmitter Tj is energized is designated M2j, the axial current measured by axial current sensor M1 when transmitter T1 is energized is designated M1i, the axial current measured by axial current sensor M2 when transmitter T1 is energized is designated M2i, the axial current measured by axial current sensor Mj when transmitter T1 is energized is designated Mji, and
wherein the electronic module (103) derives the indication of the resistivity of the formation as being approximately inversely proportional to, or the indication of the conductivity of the formations as being approximately proportional to:
$$CBi = ( Bi \times ( \frac{a \times M 1 j + b \times M 2 j}{a + b} ) + Bj \times ( \frac{a \times M 1 i + b \times M 2 i}{a + b} ) ) / Mji .$$

17. The apparatus according to claim 13, wherein the apparatus comprises:
at least four common antennas at different position along the body (102) used either as a transmitter (Ti, Tj) or as an axial current sensor (M1, M2, Mj), each common antenna being used as a transmitter while the other common antennas being used as axial current sensors, in turn, each transmitter inducing a current from a transmitter position and traveling in a path that includes a portion of the body and a selected zone (SZ) of the geological formations (GF),
a lateral current sensor comprising the space between a first (M1) and a second (M2) common antenna operated as axial current sensor, wherein the axial current measured by axial current sensor M1 when transmitter Tj is energized is designated M1j, the axial current measured by axial current sensor M2 when transmitter Tj is energized is designated M2j, the axial current measured by axial current sensor M1 when transmitter T1 is energized is designated M1i, the axial current measured by axial current sensor M2 when transmitter T1 is energized is designated M2i, the axial current measured by axial current sensor Mj when transmitter Ti is energized is designated Mji; and
wherein the electronic module (103) derives the indication of the resistivity of the formation as being approximately inversely proportional to, or the indication of the conductivity of the formations as being approximately proportional to:
CMi=|M2i×M1j−M1i×M2j|/Mji

18. The apparatus according to claim 1, wherein at least one of the transmitters is at least one of a toroidal antenna and an electrode.

19. The apparatus according to claim 1, wherein at least of the receivers is a toroidal antenna.

20. The apparatus according to claim 6, wherein the lateral current sensor is at least one of a ring electrode and a button electrode.

21. A method for determining a property of a formation surrounding a borehole, the method comprising:
movably locating an electrically conductive body (102) in the borehole;
inducing a plurality of currents at different positions on the body, each induced current having a path that includes at least a portion of the body (102) and the formation;
measuring a plurality of axial currents at different positions on the body; and
determining a virtual axial current at a position on the body that is used for determining the property of the formation, wherein the virtual axial current at said position is determined based on the measured axial currents from the plurality of receivers.

22. An apparatus used in electrical investigation of geological formations (GF) surrounding a borehole (BH), comprising:
an electrically conductive body (102) movable through the borehole (BH), at least one first transmitter (T1) for inducing a first current from a first transmitter position and traveling in a path that includes a first portion of the body and a selected zone (SZ) of the geological formations (GF),
at least one second transmitter (T2) for inducing a second current from a second position and traveling in a path that includes a second portion of the body and the selected zone (SZ), the second transmitter (T2) position being different from the first transmitter (T1) position on the body,
at least a first (M0), second (M1) and third (M2) axial current sensors for measuring a first, a second and a third axial current flowing along the body, respectively, the first, second and third axial current sensor position on the body being different from each other,
at least one lateral current sensor (R2, M0/M1, E1, E2, E3, B) disposed on the body for measuring a first electrical signal resulting from the first current and a second electrical signal resulting from the second current,
wherein the apparatus further comprises:
a virtual axial current sensor providing a virtual axial current measurement by interpolating or extrapolating two axial current measurements made at different positions which are not adjacent to the lateral current sensor, and
a calculating module (103, PA) for deriving an indication of the resistivity or conductivity of the selected zone (SZ) based on the measured first electrical signal, second electrical signal, axial currents and the calculated virtual axial current.

23. An apparatus used in electrical investigation of geological formations (GF) surrounding a borehole (BH), comprising:
an electrically conductive body (102) movable through the borehole (BH),
at least one first transmitter (T1) for inducing a first current from a first transmitter position and traveling in a path that includes a first portion of the body and a selected zone (SZ) of the geological formations (GF),
at least one second transmitter (T2) for inducing a second current from a second position and traveling in a path that includes a second portion of the body and the selected zone (SZ), the second transmitter (T2) position being different from the first transmitter (T1) position on the body,
at least a first (M0) and second (M1) axial current sensors for measuring a first and a second axial current flowing along the body, respectively, the first and second axial current sensor position on the body being different from each other, and
a virtual axial current sensor providing a virtual axial current measurement by interpolating or extrapolating the measured first and second axial current.

24. A method of electrical investigation of geological formations (GF) surrounding a borehole (BH), comprising the steps of:
positioning an electrically conductive body (102) movable through the borehole (BH) in front of a selected zone (SZ) of the geological formations (GF),
inducing a first current from a first transmitter (T1) position that travels in a path that includes a first portion of the body and the selected zone (SZ), and a second current from a second transmitter (T2) position that travels in a path that includes a second portion of the body and the selected zone (SZ), the second transmitter (T2) position being different from the first transmitter (T1) position on the body,
measuring a first and a second axial current flowing along the body, respectively, at a first (M0) and second (M1) axial current sensor position on the body that are different from each other, and
calculating a virtual axial current measurement by interpolating or extrapolating the measured first and second axial current.
